(19) United States
(12) Patent Application Publication
(10) Pub. No.: US 2025/0155597 A1
(43) Pub. Date: May 15, 2025

(54) NEAR-SURFACE P-VELOCITY ESTIMATE METHOD AND SYSTEM

(71) Applicant: CGG SERVICES SAS, Massy Cedex (FR)

(72) Inventors: Pierre HUGONNET, Pau (FR); David LE MEUR, Gif-Sur-Yvette (FR); Jean-Michel DEPREY, Paris (FR); Mathieu REINIER, Villebon sur Yvette (FR)

(21) Appl. No.: 18/947,258

(22) Filed: Nov. 14, 2024

Related U.S. Application Data
(60) Provisional application No. 63/599,095, filed on Nov. 15, 2023.

(51) Int. Cl. G01V 1/30; G01V 1/28; G01V 1/34

(52) U.S. Cl. CPC G01V 1/303; G01V 1/282; G01V 1/345

(57) ABSTRACT

A method for mapping near-surface velocities to layers of a subsurface includes receiving seismic data D associated with the subsurface, wherein the seismic data D includes at least one of P-wave energy, S-wave energy, or a mixture of P- and S-wave energy, applying a predictive deconvolution method to the seismic data D to calculate a synthetic gather F, of the subsurface, and generating a velocity model of the subsurface based on the synthetic gather F, where the velocity model maps near-surface velocities to the layers of the subsurface. A prediction deconvolution operator of the predictive deconvolution method, which corresponds to the synthetic gather F with changed sign, is a Green's function of the subsurface without any free surface.

### BACKGROUND OF THE INVENTION

### Technical Field

Embodiments of the subject matter disclosed herein generally relate to a system and method for estimating a near-surface P-velocity (compressional velocity) based on measured data, and more specifically, to estimating the near-surface P-velocity from 3-dimensional (3D) synthetic gathers that represent a Green's function of the subsurface without free surface. The near-surface velocity may be used for determining or localizing or characterizing a subsurface feature.

### Discussion of the Background

Geologists need to build velocity models for processing and analyzing seismic data. For example, recorded seismic data provides information in terms of travel times of seismic waves generated by a source and recorded at a receiver after passing through one or more layers of the subsurface. To convert these travel times into depth, geologists need to know the velocity structure (i.e., the velocity model) of the subsurface. Without an accurate velocity model, depth conversion cannot be performed reliably, leading to erroneous interpretations of subsurface structures and properties.

Another example for which a velocity model is necessary is the location of the seismic reflectors (or other subsurface features). Seismic reflectors represent boundaries between different geological formations or layers. The accuracy of interpreting these reflectors in terms of subsurface structure depends on correctly accounting for the velocity variations in the subsurface. A precise velocity model helps in accurately positioning and characterizing geological features such as faults, folds, and stratigraphic layers.

The process of seismic imaging also requires the knowledge of a velocity model and involves constructing a detailed image of the subsurface from seismic data. This requires accurately accounting for the travel paths of seismic waves through the subsurface, which is directly influenced by the velocity model. A precise velocity model improves the resolution and quality of seismic images, enabling better subsurface interpretation.

Another process that uses a velocity model is building geological models. Building geological models of the subsurface involves integrating various types of data, including seismic data, well logs, and geological maps. A velocity model serves as a main input for constructing geological models, helping to constrain the geometry and properties of geological units and improving the overall understanding of the subsurface geology, i.e., the location of various subsurface features.

Thus, building an accurate velocity model is a necessity for geologists to accurately interpret seismic data, perform depth conversion, delineate subsurface structures, and construct geological models, ultimately aiding in the exploration and development of natural resources such as oil and gas.

However, building a P-velocity model for the near-surface zone (a near-surface zone is defined herein by a distance traveled by a seismic wave, from the surface into the subsurface, typically in 1 s or less, which may correspond to an actual distance typically of 500 m or less) in both land and marine seismic data can pose challenges, especially in geological settings like the Middle East, which are characterized by thin layers and pronounced impedance variations, where velocities alternate between slow and fast. The direct identification of near-surface primary reflections, either before or after migration, can be challenging, if not entirely unfeasible, due to a variety of factors:
The near-surface primary reflections can be masked by strong noises (including surface waves and guided waves);
The near-surface primary reflections can be contaminated by strong multiple reflections; and
Depending on the acquisition geometry (including the acquisition constraints such as obstacles), the near-offset traces are missing.

Classical methods for building a near-surface velocity model include first break picking (i.e., picking the wave that arrives first, and which is generally a refracted wave), dispersion curves picking with ground-roll inversion (see discussion in [1]), or multi-wave inversion (see discussion in [2]). Picking the first breaks can be challenging in itself because of the velocity inversions, and in all cases, one of the limitations of these methods is that what is obtained at the end is an S-velocity, not a P-velocity. As briefly noted above, a P-velocity is considered in this disclosure to correspond to a compression wave, where the particles move parallel to the propagation direction of the wave, while an S-velocity is considered to correspond to a shear wave, where the particles move perpendicular to the propagation direction of the wave.

An elastic Full Waveform Inversion (FWI) method is in principle able to estimate a P-velocity model of the near-surface, but it generally needs a reasonably correct initial velocity model [3], which is often not available.

The near-surface reflectivity can also be reconstructed using surface-consistent predictive deconvolution, called herein simply “predictive deconvolution.” By design, the 1D deconvolution operators are obtained at the surface datum, and they are supposed to be free of surface multiples. If estimated with care by selecting appropriate estimation windows, the 1D deconvolution operators contain mostly the primary energy, with a minimal amount of internal multiple energy and no surface waves, and therefore can be used to image the near-surface [4].

Multidimensional extensions of the classical predictive deconvolution method have been described in the past years, and they can estimate pre-stack operators with offsets [5]. These operators reproduce the kinematics of the primary reflections and open the possibility of velocity analysis and model building [6].

However, the methods and algorithms associated with references [1-3] either do not allow a velocity model update or rely on the availability of an accurate starting velocity model, which, as noted above, sometimes is not the case. The methods associated with reference [4] cannot estimate a velocity model and thus, the velocity model cannot be updated while references [5-6] are using a traditional velocity model update procedure. However, in both cases, the methods are prone to be trapped in local minima, i.e., the cycle-skipping issue. Thus, there is a need for a method that is capable of estimating the near-surface P-velocity relying exclusively on the collected seismic data.

### SUMMARY OF THE INVENTION

According to an embodiment, there is a method for mapping near-surface velocities to layers of a subsurface, and the method includes receiving seismic data D associated with the subsurface, wherein the seismic data D includes at least one of P-wave energy, S-wave energy, or a mixture of P- and S-wave energy, applying a predictive deconvolution method to the seismic data D to calculate a synthetic gather F, of the subsurface, and generating a velocity model of the subsurface based on the synthetic gather F, wherein the velocity model maps near-surface velocities to the layers of the subsurface. A prediction deconvolution operator of the predictive deconvolution method, which corresponds to the synthetic gather F with changed sign, is a Green's function of the subsurface without any free surface.

According to another embodiment, there is a computing system for mapping near-surface velocities to layers of a subsurface and the computing system includes an interface configured to receive seismic data D associated with the subsurface, wherein the seismic data D includes at least one of P-wave energy, S-wave energy, or a mixture of P- and S-wave energy, and a processor connected to the interface. The processor is configured to apply a predictive deconvolution method to the seismic data D to calculate a synthetic gather F, of the subsurface, and generate a velocity model of the subsurface based on the synthetic gather F, wherein the velocity model maps near-surface velocities to the layers of the subsurface. A prediction deconvolution operator of the predictive deconvolution method, which corresponds to the synthetic gather F with changed sign, is a Green's function of the subsurface without any free surface.

According to yet another embodiment, there is a non-transitory computer readable medium including computer executable instructions, where the instructions, when executed by a processor, implement a method for mapping near-surface velocities to layers of a subsurface as discussed herein.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of a seismic acquisition system having a source and a receiver;

FIG. 2 schematically illustrates surface multiples;

FIG. 3 schematically illustrates how the surface multiples may be split into primaries and other paths, for removing the surface multiples;

FIG. 4 is a flowchart of a method for calculating near-surface P-velocity based on synthetic gathers;

FIG. 5 illustrates a dense carpet shooting for collecting seismic data for generating the synthetic gathers;

FIG. 6A shows synthetic receiver gathers estimated by a predictive deconvolution on the seismic data while FIG. 6B shows the receiver gathers after deblending, linear and random noise attenuation, and NMO with an approximate velocity model;

FIG. 7A shows common image gathers obtained by depth migration of the synthetic gathers of FIG. 6A, and FIG. 7B shows common image gathers obtained by depth migration of the receiver gathers of FIG. 6B;

FIG. 8A illustrates an updated velocity model after tomographic inversion, based on synthetic gathers, and FIG. 8B illustrates a comparison between the updated velocity model and a well velocity log;

FIG. 9A shows common image gathers obtained by depth migration of the updated synthetic gathers of FIG. 7A and FIG. 9B shows common image gathers obtained by depth migration of the updated receiver gathers of FIG. 7B; and

FIG. 10 is a schematic diagram of a computing device that supports one or more of the methods discussed herein.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to seismic data acquired with a land seismic survey. However, the embodiments to be discussed next are not limited to land seismic data, but may be applied to other types of data, for example, marine seismic data, or electromagnetic data.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a multidimensional predictive deconvolution method is used together with acquired seismic data D to generate synthetic gathers. The synthetic gathers are built using receiver-side multiples or source-side multiples. Depending on the context, one of these two types of synthetic gathers are used for generating a near-surface P-velocity model and then, an image of the subsurface is produced based on the P-velocity model. The image of the subsurface identifies one or more geological features (e.g., a fault) in the subsurface, which may be indicative of the presence of a resource, for example, oil and gas, ore, etc. The image may also be used for determining the best location for a CO₂ reservoir or where to place a wind turbine.

In other words, the techniques described in these embodiments are not limited to subsurface exploration alone. They can be utilized across various fields such as geothermal exploration and development, carbon capture and sequestration, as well as other natural resource exploration and utilization endeavors. Moreover, these methods hold potential for surveying and monitoring in windfarm applications, whether on land or at sea. Additionally, they could find applications in medical imaging.

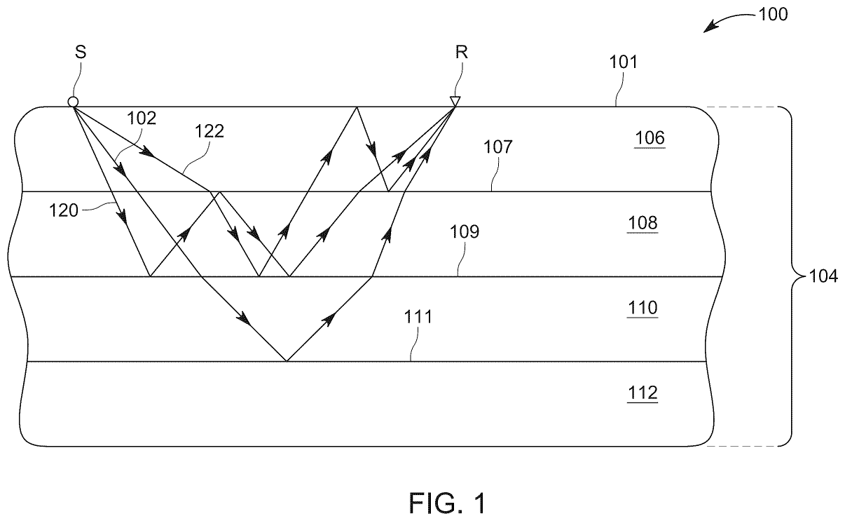

Before discussing the details of calculating the synthetic gathers based on the multidimensional predictive deconvolution for generating the near-surface P-velocity model, a brief discussion about the surface multiples estimation is presented. During the seismic data collection, as shown in FIG. 1, one or more sources S located at the surface 101, generate seismic waves 102 (e.g., acoustic waves) into the earth. The waves 102 propagate into the subsurface 104 through one or more layers 106 to 112. The figure shows only four layers, but more or less layers may be present. At the interfaces 107 to 111 of two adjacent layers, the wave 102 may experience a reflection or refraction. When a reflection takes place, as shown in the figure at interface 111, the wave changes its direction and moves upward, until recorded at a receiver R. The receiver may be a geophone or accelerometer for a land seismic acquisition 100 or a hydrophone and/or accelerometer for a marine seismic acquisition. While the figure shows a raypath 102 that experiences a single reflection, i.e., a primary wave, from the source S to the receiver R, many other raypaths may be present that might experience plural reflections or no reflections before being recorded by the receiver R. These waves form multiples, which are discussed later.

During a seismic survey, it is typical for the source S to move around the surface 101 and fire at different locations. The system includes plural receivers R, which are provided at fixed positions. The receivers are configured to record all the waves as (primaries and multiples), at plural times. Thus, there are hundreds of thousands of waves recorded by the seismic receivers during a seismic survey and the recordings of the receivers are called traces.

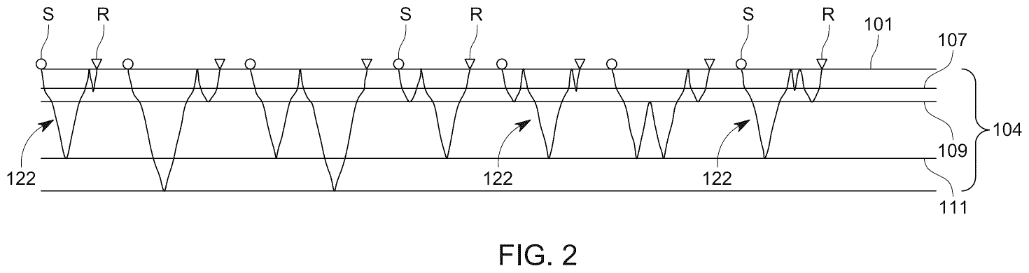

While FIG. 1 shows the wave 102 propagating from the source S to the receiver R and experiencing a single reflection at interface 111 (which is considered to be the reflector and this wave is called a primary), in reality, waves from the source S may experience more than one reflection before arriving at the receiver. For example, FIG. 1 shows wave 120 experiencing an internal reflection at interface 107 (in addition to two reflections at interface 109) before arriving at the receiver R. This wave is called an internal multiple. The same figure also shows a wave 122 experiencing a surface reflection (at the surface 101, in addition to two reflections at interfaces 107 and 109) before arriving at the receiver R. This wave is called a surface multiple because of the surface reflection. Wave 122 is shown in more detail in FIG. 2. The wave 122 can be reflected at various interfaces of the subsurface 104 and at least once at the surface 101. In the following, the primary and the internal multiples are treated as a single wave (i.e., they are not separated from each other) and they are denoted herein as P. Thus, Prefers herein to the combination of primaries and internal multiples, or a “combined primary” or “contaminated primary.” The surface multiples are denoted as M. The recorded data D includes both the combined or contaminated primaries P and the surface multiples M, i.e., D=P+M.

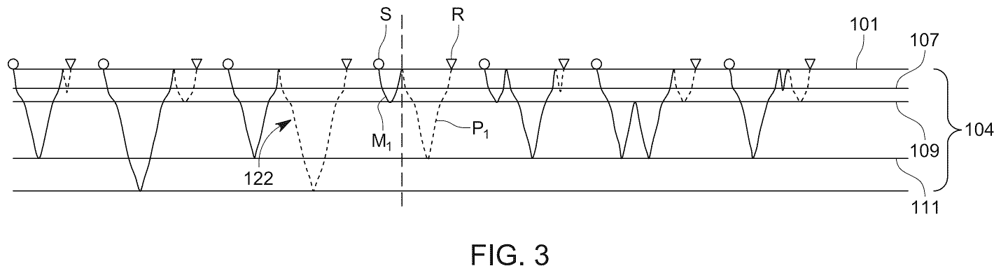

As the multiples obscure the primaries, which is the actual seismic data that is used for imaging the subsurface in this embodiment, one goal of the seismic processing is the removal of the multiples. One technique for achieving this goal is the surface-related multiple elimination (SRME) method. This method relies on the concept that the surface multiples M, as illustrated in FIG. 3, can be decomposed into primaries P1 and a shorter travel path M1 (typically another multiple). If the receivers R and/or the sources S are densely distributed, for example, between 10 and 50 m along the X and Y directions in the plane of the surface 101, then each primary P1 and shorter travel path M1 are likely recorded by a pair of source and receiver. If each wave of the shot gather corresponding to M1 and each wave of the receiver gather corresponding to P1 are convolved with each other, then the surface multiples M can be predicted, exclusively based on the collected seismic data D, with no need for a velocity model. Traditionally, the predicted multiples M are then iteratively subtracted from the recorded data D to obtain the primaries P.

The SRME method considers that:

$$P = D - M , \qquad ( 1 )$$

and requires the calculation of the primaries, which is performed, for example, based on equation:

$$P = D + D ⊗ P * {s}^{- 1} , \qquad ( 2 )$$

where s is a source wavelet, usually not known, operation “⊗” is a multidimensional integral operation (e.g., a multidimensional convolution) defined in equation (3) below, and operation “*” is the 1D convolution operation. The multidimensional integral operation is defined as:

$$( D ⊗ P ) ( t , {x}_{s} , {x}_{r} ) = {\int \int }_{x} D ( t , {x}_{s} , x ) * P ( t , x , {x}_{r} ) dx , \qquad ( 3 )$$

where D and P are multidimensional operators, i.e., can be written as D/P(t, xₛ, xᵣ), where xₛ is the source position and xᵣ is the receiver position (xₛ and xᵣ being a single (x) coordinate for a 2D formulation or (x, y) coordinates for a 3D formulation). Thus, a surface modelling equation for the multiples is given by:

$$M = - D ⊗ P * {s}^{- 1} , \qquad ( 4 )$$

where D or P represent the full 5D prestack volume. The 5D prestack volume is associated with the recorded traces, which depend on the position of the source S (i.e., x_{S} and y_{S}), the position of the receiver R (i.e., x_{R} and Y_{R}), and time (a total of 5 dimensions).

There are many ways to solve equation (4), for example by using an adaptive subtraction operator f,

$$P \approx D + f * D ⊗ D . \qquad ( 5 )$$

In this approach, the term D⊗D instead of DOP is kinematically correct but does not correctly describe the amplitudes. The adaptive subtraction operator f is used to both retrieve the amplitudes and to estimate the source wavelet s⁻¹. After a first estimate of the primary P is obtained, the solution can be iterated.

Another approach in solving equation (2) is using an inversion approach, as described in [5]. For this approach, the SRME equation (2) can be rewritten as:

$$P = D + D ⊗ F , \qquad ( 6 )$$

where the operator F is selected to reproduce the expected kinematics of P, even where P has not been properly recorded.

The deconvolution operator F may be estimated by a least-squares inversion, i.e., under the (reasonable) assumption that the resulting primaries have minimal energy after removal of the multiples,

$$\hat{F} = arg {min}_{F} {‖ P = D + D ⊗ F ‖}^{2} , \qquad ( 7 )$$

which was originally described in [5]. In this approach, the operator F is a Green's function of the medium without the free surface.

In the context of seismic processing, the Green's function refers to the impulse response of the Earth's subsurface to a point source of seismic energy (e.g., the source S). It represents how seismic waves 102 propagate through the Earth from the source point S to the receiver R's location. This Green's function is used to model and interpret seismic data. When seismic waves are generated at the source S, they travel through the subsurface, interacting with different geological layers and structures along the way. The Green's function encapsulates the effects of these interactions, including reflections, refractions, scattering, and attenuation, among others. Thus, the Green's function accounts for the Earth's properties, such as velocity variations, density contrasts, and geometrical complexities. The Green's function is used in various seismic processing techniques, including seismic migration, waveform inversion, velocity modeling, and imaging of subsurface structures. By understanding and accurately estimating the Green's function, seismic interpreters can extract valuable information about the Earth's subsurface and improve their understanding of geological features and processes.

The classical 1D predictive deconvolution that has been used for decades is a particular/restricted case of equation (7), which works trace by trace. The data D (t), the primary P (t), and the deconvolution operator F (t) are single traces, and equation (7) becomes (using a simple 1D convolution “*” instead of the multidimensional integral operator “⊗”):

$$\hat{F} = arg {min}_{F} {‖ P = D + D * F ‖}^{2} , \qquad ( 8 )$$

In this classical 1D (trace by trace) formulation, the deconvolution operator F(t) is typically defined on a [gapmin, tmaxf] time range. The gapmin is a small positive time related to the seismic wavelet length, for example, equal to the seismic wavelet length, and tmaxf is a fraction of the data trace length, for example, between about 1/10 and ⅕ of the data trace length. Those skilled in the art would understand that the values for the gapmin and tmaxf are presented as an example, and they may be changed as necessary.

The rationale for [gapmin, tmaxf] time range can be directly transposed to the multidimensional case, i.e. the deconvolution operator F (t, xₛ, xᵣ) of equation (6) is also defined on this time range.

The underlying assumption of the predictive deconvolution is that the desired result (the deconvolved data) forms a gaussian random sequence, or, in other terms, that its autocorrelation is a Dirac function. In practice, because the bandwidth of the seismic source is limited and because the data are recorded over a limited duration, this assumption is relaxed to the autocorrelation of the desired result being zero over the [gapmin, tmaxf] time range.

In the 1D formulation in equation (8), the operator \hat{F}(t) is supposed to model normal incidence (zero offset) data, and supposed to contain the reflectivity of the primary reflections that generate the surface multiples according to [7]. This property can be used to reconstruct the near-surface reflectivity, as discussed, for instance, in [4]. In the full 5D formulation in equation (7), the operator \hat{F}(t, xₛ, xᵣ) has in addition offset dimensions and contain offset-dependent reflectivities and the full kinematics of the primary reflections.

Combining the SRME formalism (see equation (2) and its description above) with the multidimensional predictive deconvolution, the deconvolution operator f can be interpreted, except for the sign, as the deconvolved (i.e., with the source wavelet removed) primary wavefield P1 in FIG. 3:

$$F ≡ {s}^{- 1} * P . \qquad ( 9 )$$

In other words, the deconvolution operator F, on the time window where it is defined, is the Green's function of the subsurface without any free surface, and thus, this explains the origin of the terminology “synthetic gather” used in this disclosure. The deconvolution operator F(t, xₛ, xᵣ) with fixed xₛ is the synthetic shot gather and F(t, xₛ, xᵣ) with fixed xᵣ is the synthetic receiver gather. These gathers can be migrated to generate synthetic common image gathers (CIGs), which are used for forming the image of the subsurface.

It is noted that this approach is a fully data-driven process, i.e., the operator F can be obtained without any a priori knowledge of the subsurface, and in particular, no initial or starting velocity model is needed.

As described above, the predictive deconvolution method addresses the receiver-side multiples. To address the source-side multiples, equation (9) is modified as follows:

$$\hat{F} = arg {min}_{F} {‖ D ∓ F ⊗ D ‖}^{2} . \qquad ( 10 )$$

There is no distinction between equations (7) and (10) in 1D, because the simple time convolution is commutative in 1D, i.e., F*D=D*F. This is however no longer true in multidimensions, i.e., F⊗D≠D⊗F. While this is relevant for multiple attenuation (which was the original motivation of the predictive deconvolution), this is not really a problem when generating the synthetic gathers. With the receiver-side formulation it is possible to obtain synthetic receiver gathers, and with the source-side formulation it is possible to obtain synthetic shot gathers. With 3D data, the choice between the two formulations depends on the acquisition geometry.

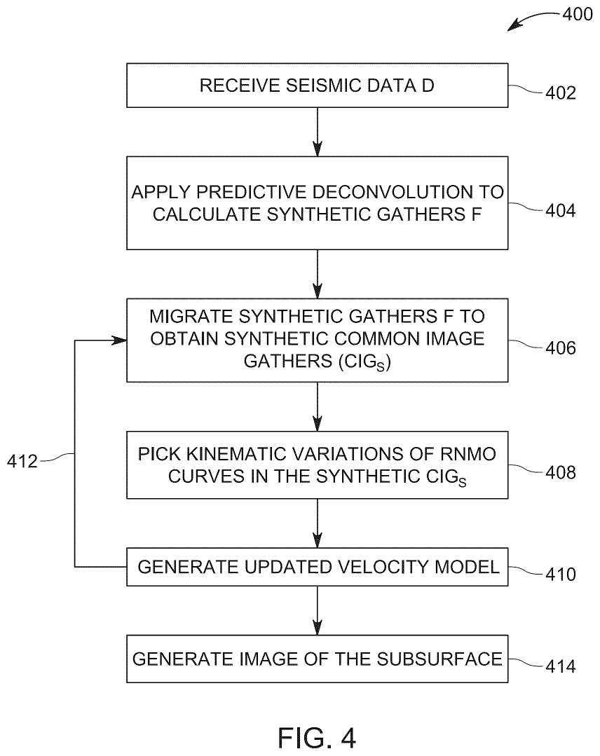

A method for using the above approach for generating an image of the subsurface is discussed with regard to FIG. 4. The method 400 starts with a step 402 of receiving seismic data D, which can be land or marine data. The seismic data D may be received from a client or may be collected by known means by the operator of the method. In step 404, a multidimensional predictive deconvolution (discussed above) is applied to the seismic data D to calculate the synthetic gathers f. If the receiver-side gather is desired to be used, then equation (9) is used. If the source-side gather is desired to be used, then equation (10) is used. These gathers mainly contain energy corresponding to primary reflections (see P1 in FIG. 3) free of surface multiples. As discussed above, these synthetic gathers correspond to the Green's function of the medium without the free surface.

The primary reflections P1 contained in the synthetic gathers exhibit kinematic variation regarding offsets along the x and y directions. The term “kinematic” is used in this application to describe geometric aspects of seismic wave propagation, such as travel times, ray paths, and wavefront shapes, without necessarily considering the amplitude or waveform characteristics.

In step 406, the synthetic gathers F are migrated to obtain the synthetic CIGs. In one application, the migration is based on a constant velocity, for example, about 3000 m/s, for the entire subsurface. Other values may be used. Note that a velocity model provides different velocities for different layers in the subsurface, which is not the case for this step. However, in one application, it is possible to migrate the operators with a non-constant velocity model. A traditional CIG was in the past calculated based on a common midpoint gather (CMP) or a common reflection point (CRP) gather. More specifically, once seismic traces have been gathered based on either CMP or CRP, they were further processed and stacked to enhance the signal-to-noise ratio and improve the resolution of subsurface images. The resulting gather is known as the CIG. CIGs provide a comprehensive view of the subsurface at a specific location and are used for interpreting seismic data and identifying geological features such as faults, folds, and hydrocarbon reservoirs.

In step 408, a kinematic variation (e.g., curvature) of residual normal moveout (RNMO) curves in the synthetic CIGs can be picked, in time or depth. In seismic processing, the NMO (Normal Moveout) curve is a tool used to correct for the effects of velocity variations in the subsurface when interpreting seismic data. It represents the relationship between the travel time of seismic reflections and the offset between the seismic source and receiver. Briefly, seismic waves travel at different velocities through different subsurface layers. Consequently, reflections from deeper layers arrive later than reflections from shallower layers, causing a time-offset known as moveout. The NMO correction compensates for this moveout, ensuring that seismic reflections are accurately positioned in time.

The NMO curve is typically plotted as travel time versus offset for a specific reflector or reflection event. It is derived from the relationship between the moveout velocity of seismic waves and the offset distance between the source and receiver. The curve is often described by a hyperbolic function. By applying the NMO correction, seismic reflections are flattened in the time domain, facilitating interpretation and accurate imaging of subsurface structures. The NMO curve is used in seismic processing for velocity analysis, imaging, and depth conversion.

Residual NMO curves, on the other hand, are deviations from the primary NMO curve. They represent discrepancies between the predicted moveout and the actual moveout observed in seismic data. Residual NMO curves can arise due to factors such as velocity model inaccuracies, lateral velocity variations, anisotropic effects, or errors in seismic acquisition geometry.

Analyzing residual NMO curves (e.g., their curvatures) is used for refining velocity models and improving the accuracy of seismic processing results. Residual moveout analysis helps identify areas of the subsurface where the velocity model may need adjustment, leading to more reliable interpretations of seismic data and better imaging of subsurface structures.

In step 410, the RNMO curves from the synthetic gathers are fed to a velocity analysis method (e.g., NMO velocity analysis, migration velocity analysis, reflection tomographic inversion, waveform tomography, or FWI) to generate an updated velocity model. In one application, the picked kinematic variation (e.g., curvature of the RNMO curves) in step 406 is minimized (or maximized) to generate the updated velocity model. It is noted that until this point, no initial or given velocity model was used in any of the above steps, except for the migration of the operators in step 406, which may be an approximate velocity model (note that many seismic methods, e.g., FWI, require an accurate velocity model). In other words, the generation of the velocity model in this step is purely data-based. The velocity model generated in step 410 is for near-surface P-velocities. This step estimates the near-surface P-velocities for the layers in a given volume of the subsurface, essentially associating each layer in the given volume with its corresponding P-velocity. This mapping between the layers of the subsurface and the P-velocities may be later used for propagating the various seismic waves into the ground, for generating an image of the subsurface, the image including one or more geological features (e.g., salt, fault, river, etc.) present into the subsurface. This specific seismic data processing method is an indispensable tool for those in the field that operate an exploration well, or a CO₂ reservoir, or form the foundation of a bridge or wind turbines.

The algorithm may return in step 412, for example, based on whether the velocity model satisfies a given threshold or criteria, to step 406 for migrating the synthetic gathers based on the velocity model generated in step 410 instead of the constant velocity originally used in step 406. The loop 412 may be repeated until a desired quality of the velocity model is achieved.

Then, the algorithm may proceed to generate, in step 414, an image of the subsurface based on synthetic CIGs calculated based on the latest velocity model. The image of the subsurface essentially maps various features of the subsurface to their physical locations, allowing the operator on the ground to drill a well or to excavate into a desired feature (e.g., fault or salt) or to avoid such a feature.

It is noted that the internal multiples (discussed above with regard to FIGS. 1 to 3) are considered in this method to be part of the primaries, so that the concept of “contaminated primaries P” was used in the predictive deconvolution method in step 404. By design of the predictive deconvolution, the synthetic gathers are supposed to be free of surface multiples. However, they can still contain some virtual energy that does not correspond to any actual primary reflection, because of the presence of the internal multiples in the data. Thus, it is assumed in this method that in the time window that is used for estimating the synthetic gathers, the internal multiple energy is an order of magnitude below the surface multiple one. This assumption is sound as the internal multiple generation mechanism is cumulative with increasing times, while the surface multiple generation mechanism is stationary: on the shallow part of the data, the surface multiples are therefore dominant, while the internal multiples become dominant at higher times.

The above discussed embodiments assume that the recorded data contain mainly P-wave energy, which is generally the case when the data acquisition is made with dynamite or vertical vibrators or marine sources on the source side, and with vertical geophones or hydrophones on the receiver side. Such data are usually named “PP”. Consequently, the synthetic gathers built from PP data also contain mainly P-wave (PP) energy.

“PS” data are another common case, and this data is typically obtained by using horizontal geophones on the receiver side. For this scenario, the aim is to record mainly the converted waves (the P waves emitted by the source are converted to reflected S waves in the subsurface). This is an asymmetric configuration, therefore the synthetic gathers built from PS data will differ, depending on which side they are built: they will contain mainly SS energy on the receiver side, and mainly PP energy on the source side.

PS data may also be acquired with a source emitting mainly S waves (e.g., a horizontal vibrator) and vertical geophones. This data may be described as “SP” data. In this case, the synthetic gathers built on the receiver side will contain mainly PP energy, and the synthetic gathers built on the source side will contain mainly SS energy.

Further, one may consider the “SS data” case, with a source emitting mainly S waves and horizontal geophones. In this case, the synthetic gathers will contain mainly SS energy, whichever the side they are built.

For the embodiments discussed above, which aim at building a P-wave velocity model, it turns out that in addition to PP data, PS or SP data could be used, by selecting the appropriate side to build the synthetic gathers (as long as the synthetic gathers contain mainly PP energy). Building an S-wave velocity model would also be possible by using PS, SP, or SS data due to the synthetic gathers containing mainly SS energy.

Also note that the embodiments discussed above may use not only land data, but also marine data instead of the land data.

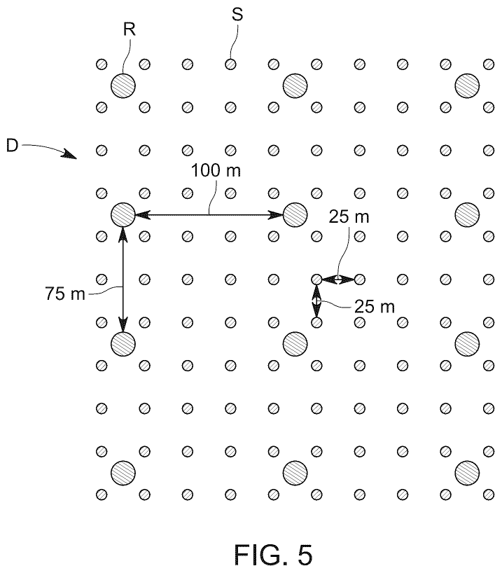

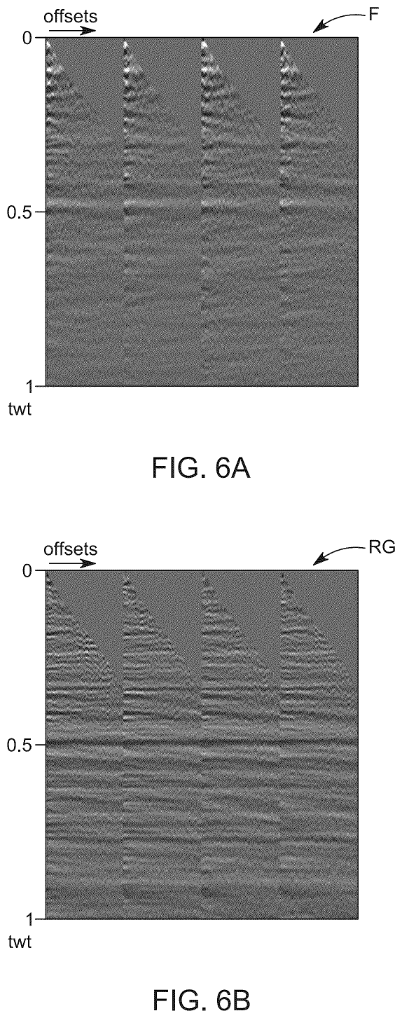

An application of the method 400 to real data is discussed now with regard to FIGS. 5 to 9B. FIG. 5 schematically illustrates a dense carpet shooting configuration, with source shootings on a 25 by 25 m grid and with receivers R distributed on a 100 by 75 m grid. The seismic data D received in step 402 is acquired with this configuration for this embodiment so that the assumption discussed above with regard to FIG. 3 is true. The synthetic gather F calculated as discussed above is illustrated in FIG. 6A while FIG. 6B illustrates a traditional receiver gather RG after deblending, linear and random noise attenuation, and NMO performed with an approximate velocity model. Note that no velocity model has been used for calculating the synthetic gather F. The X axis for both gathers is the offset between the source and receiver and the Y axis for both gathers is the travel wave time (twt) for the waves 102, in seconds. Note that the twt is 1 second, for accounting for the goal of calculating the near-surface P-velocity.

The multidimensional predictive deconvolution applied to the synthetic gather Fin FIG. 6A uses, in this embodiment, a simplified formulation under the horizontally layered geology assumption [9]. Although the input data are reasonably clean, it can be observed that the input data in FIG. 6B are contaminated by a significant amount of what is interpreted as surface multiples, with conflicting curvatures. In contrast, the synthetic gathers in FIG. 6A appear to be simpler, with less conflicting curvatures.

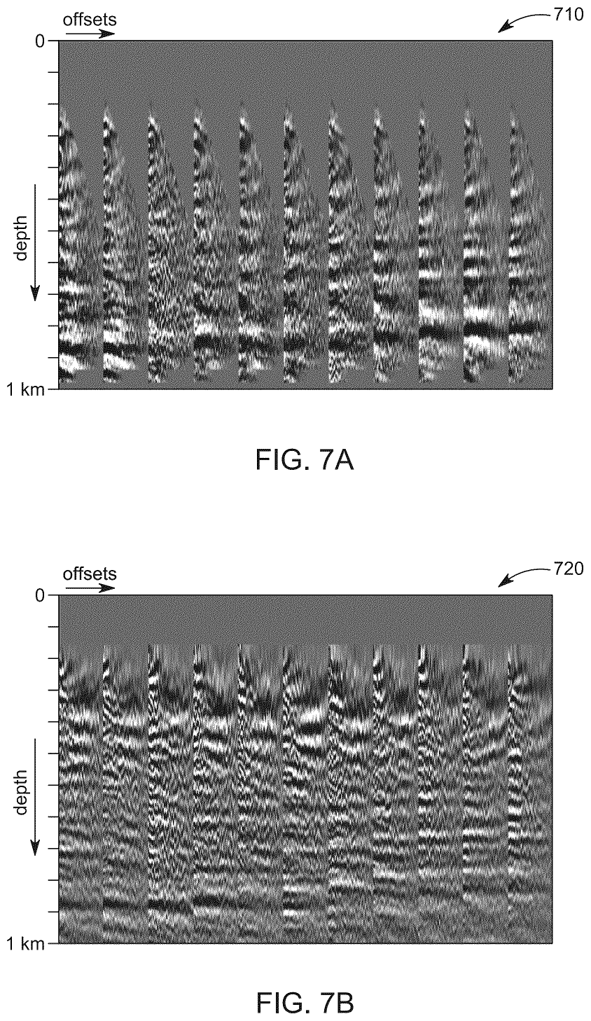

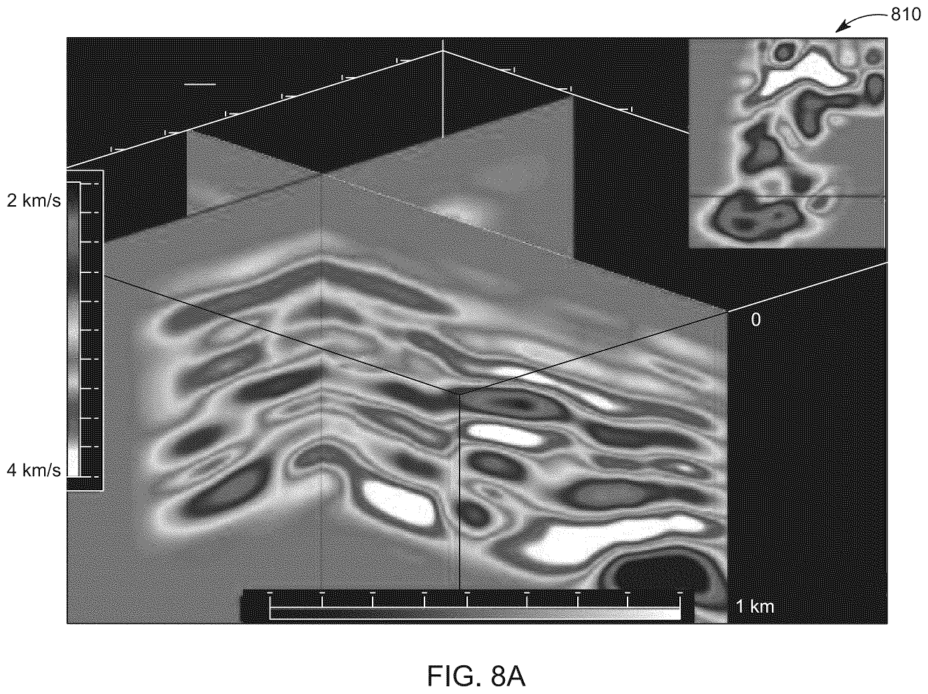

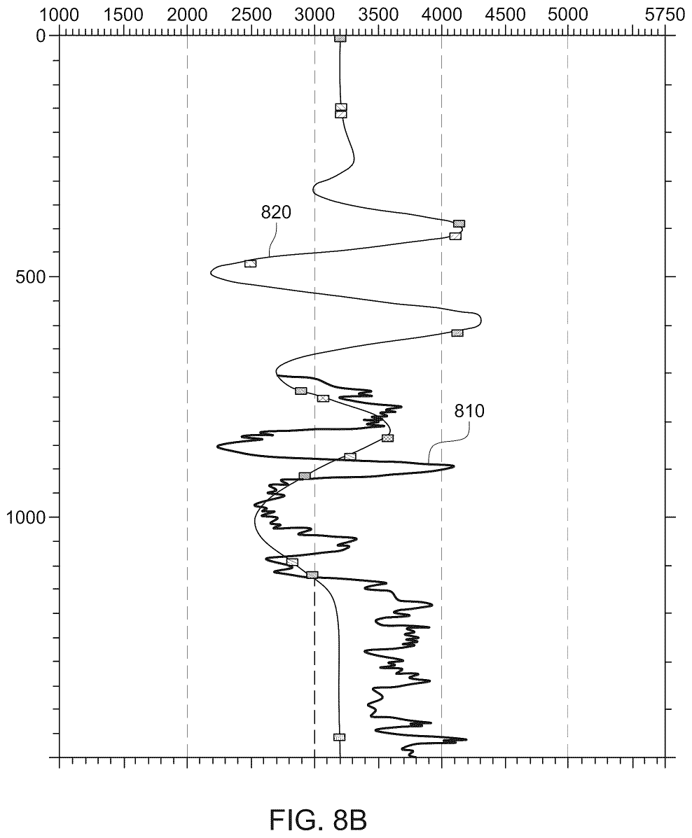

Using an initial velocity model (or, for example, just a constant velocity for all the layers of the studied subsurface, as discussed above with regard to step 406), the synthetic gathers F can be migrated to build the synthetic CIGs 710, illustrated in FIG. 7A. It can be observed that the synthetic CIGs are cleaner and simpler than the real data CIGs 720 illustrated in FIG. 7B. The residual curvatures are picked (step 408) on these virtual CIGs and input to the tomographic inversion (step 410). This action results in an updated velocity model 810, as illustrated in FIG. 8A, which effectively captures vertical velocity variations, with trends that fit reasonably well to a well velocity log 820 illustrated in FIG. 8B (although the log is not available in the very near surface). FIG. 8B plots the velocity (values in m/s illustrated on the X axis) for various depths or layers (values in m illustrated on the Y axis). Note that the velocity model 810 is a P-velocity, near-surface model, describing the velocity up to about 1 km deep.

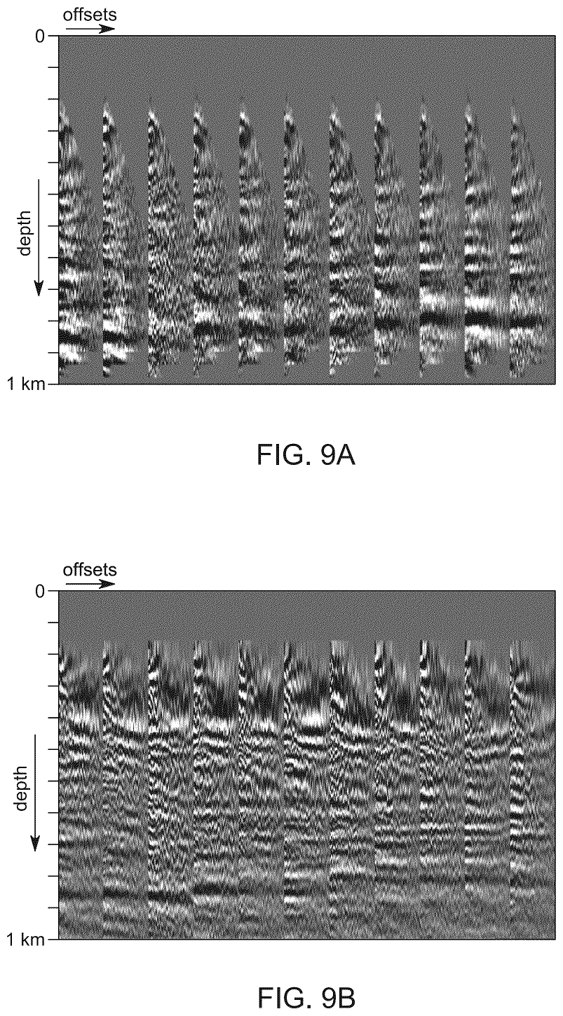

After performing a loop 412, and using the velocity model 810 calculated based on the synthetic gather F, the synthetic and real data CIGs are recalculated as shown in FIGS. 9A and 9B, respectively. Both gathers are better flattened and show a better lateral continuity of the events. As the seismic data may include various types of information related to geological characteristics of subsurface geological structures, the method may be used to determine these subsurface features/structures. The subsurface geological structures may include different components (e.g., rocks, underground water, oils, salts, ores, sands, or the like) that may have different properties (e.g., elasticity, electric conductivity, Young's modulus, or the like), which may affect characteristics (e.g., velocities, magnitudes, phases, frequencies, or the like) of the seismic waves that pass through them. By analyzing the seismic data, the above described subsurface features may be determined.

Variations of the method discussed above with regard to FIG. 4 may be implemented. For example, in one embodiment, a simplified multi-dimensional deconvolution may be used in step 404, for instance, under the assumption of horizontally layered data in the subsurface. In this case, the predictive deconvolution can be applied input gather by input gather (no matter the gather: shot, receiver, or cross-spread), instead of a global inversion involving the whole survey.

In another embodiment, the predictive deconvolution may directly estimate synthetic CIGs I(z, x, h) by incorporating a modelling operator My (for example, the transpose of the migration operator), in the case where an approximate velocity model V is available, in which case:

$$\hat{I} = arg {min}_{F} {‖ D ∓ D ⊗ {M}_{V} ( I ) ‖}^{2} , \qquad ( 11 )$$

where I(z, x, h) with x fixed is a virtual common image gather and I(z, x, h) with h fixed is an image for a given offset class, and h is the offset between the source and the receiver.

Alternatively, the synthetic common image gathers could be obtained in the angle domain, with an appropriate modelling operator with the assumption of a well-known velocity field [10].

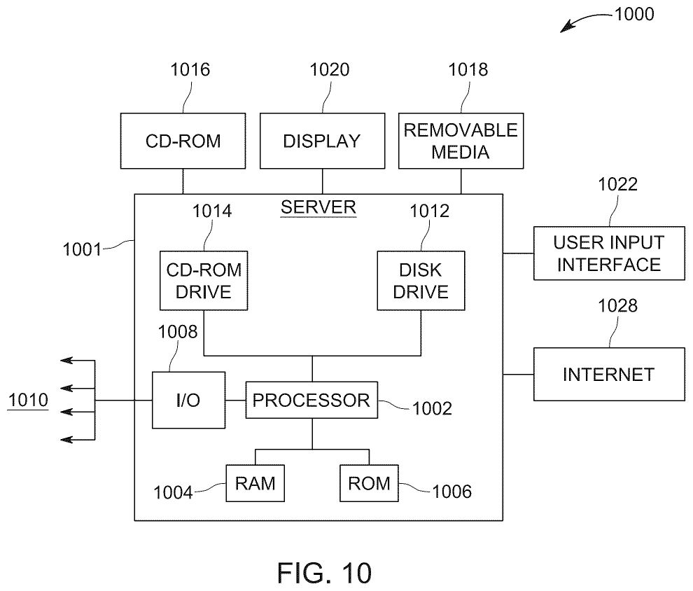

The above-discussed procedures and methods may be implemented in a computing device as illustrated in FIG. 10. Hardware, firmware, software or a combination thereof may be used to perform the various steps and operations described herein. The computing device 1000 is suitable for performing the activities described in the above embodiments and may include a server 1001. Such a server 1001 may include a central processor (CPU) 1002 coupled to a random access memory (RAM) 1004 and to a read-only memory (ROM) 1006. ROM 1006 may also be other types of storage media to store programs, such as programmable ROM (PROM), erasable PROM (EPROM), etc. Processor 1002 may communicate with other internal and external components through input/output (I/O) circuitry 1008 and bussing 1010 to provide control signals and the like. Processor 1002 carries out a variety of functions as are known in the art, as dictated by software and/or firmware instructions.

Server 1001 may also include one or more data storage devices, including hard drives 1012, CD-ROM drives 1014 and other hardware capable of reading and/or storing information, such as DVD, etc. In one embodiment, software for carrying out the above-discussed steps may be stored and distributed on a CD-ROM or DVD 1016, a USB storage device 1018 or other form of media capable of portably storing information. These storage media may be inserted into, and read by, devices such as CD-ROM drive 1014, disk drive 1012, etc. Server 1001 may be coupled to a display 1020, which may be any type of known display or presentation screen, such as LCD, plasma display, cathode ray tube (CRT), etc. A user input interface 1022 is provided, including one or more user interface mechanisms such as a mouse, keyboard, microphone, touchpad, touch screen, voice-recognition system, etc.

Server 1001 may be coupled to other devices, such as seismic source, seismic sensor, CT scan, MRI machine, or any other data imaging systems. The server may be part of a larger network configuration as in a global area network (GAN) such as the Internet 1028, which allows ultimate connection to various landline and/or mobile computing devices.

As described above, the apparatus 1000 may be embodied by a computing device. However, in some embodiments, the apparatus may be embodied as a chip or chip set. In other words, the apparatus may include one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 1002 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 1002 may be configured to execute instructions stored in the memory device 1004 or otherwise accessible to the processor. Alternatively, or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

The term “about” is used in this application to mean a variation of up to 20% of the parameter characterized by this term. It will be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

The disclosed embodiments provide a method and associated system that calculates a velocity model in near-surface based on synthetic gathers, which are exclusively calculated from recorded seismic data. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Bardainne, T., Garceran, K., Retailleau, M., Duwattez X., Sternfels, R., Le Meur, D., 2017, Laterally Constrained Surface Wave Inversion, 79th EAGE Conference & Exhibition.
[2] Bardainne T., 2018, Joint inversion of refracted P-waves, surface waves and reflectivity. 80th EAGE Conference & Exhibition.
[3] Sedova, A., Royle, G., Hermant, O., Retailleau, M., Lambaré, G., 2017, High-resolution Land Full Waveform Inversion-A Case Study on a Data Set from the Sultanate of Oman, 79th EAGE Conference & Exhibition.
[4] Retailleau, M. G., 2015, Imaging the Near Surface Using Surface-consistent Prediction Operators—Examples from the Middle East: 77th EAGE Conference and Exhibition.
[5] Biersteker, J., 2001, MAGIC: Shell's surface multiple attenuation technique: SEG Technical Program Expanded Abstracts 2001, 1301-1304.
[6] Guillaume, P., Lambaré, G., Sioni, S., Carotti, D., Dépré, P., Culianez, G., Montel, J.-P., Mitouard, P., Depagne, S., Frehers S. and Vosberg, H., 2011, Geologically consistent velocities obtained by high definition tomography. 81st Annual International Meeting, SEG, Expanded Abstracts, 30, 4061-4065.
[7] Backus, M. M., 1959, WATER REVERBERATIONS-THEIR NATURE AND ELIMINATION: GEOPHYSICS, 24, 233-261.
[8] Verschuur, D. J., Berkhout, A. J., Wapenaar, C. P. A., 1992: Adaptive surface-related multiple elimination, Geophysics, 57, 9.
[9] Hugonnet, P., J. L. Boelle, P. Herrmann, F. Prat, and S. Navion, 2010, 3D Predictive Deconvolution for Wide-azimuth Gathers: 72nd EAGE Conference and Exhibition.
[10] Poole, G., and J. Tickle, 2023, Wave-equation deconvolution for angle-dependent reflectivity and internal multiple prediction: 84th EAGE Annual Conference & Exhibition, 1-5.

What is claimed is:

1. A method for mapping near-surface velocities to layers of a subsurface, the method comprising:
receiving seismic data D associated with the subsurface, wherein the seismic data D includes at least one of P-wave energy, S-wave energy, or a mixture of P- and S-wave energy;
applying a predictive deconvolution method to the seismic data D to calculate a synthetic gather F, of the subsurface; and
generating a velocity model of the subsurface based on the synthetic gather F, wherein the velocity model maps near-surface velocities to the layers of the subsurface,
wherein a prediction deconvolution operator of the predictive deconvolution method, which corresponds to the synthetic gather F with changed sign, is a Green's function of the subsurface without any free surface.

2. The method of claim 1, wherein the synthetic gather F is calculated based on the seismic data D, and a convolution term between the seismic data D and contaminated primaries P, where the contaminated primaries P includes pure primaries and internal multiples.

3. The method of claim 2, wherein the convolution term between the seismic data D and the contaminated primaries P is multiplied by an inverse of a source wavelet s, which describes a source that generates the seismic data D.

4. The method of claim 2, wherein the convolution term convolves the seismic data D with the contaminated primaries P, in this order, to obtain a receiver-side synthetic gather F.

5. The method of claim 2, wherein the convolution term convolves the contaminated primaries P with the seismic data D, in this order, to obtain a source-side synthetic gather F.

6. The method of claim 1, wherein the synthetic gather F is a function of (1) time, (2) a position of a source that generates the seismic data D, and (3) a position of a receiver that records the seismic data D.

7. The method of claim 1, further comprising:
migrating the synthetic gather F to obtain a synthetic common image gather.

8. The method of claim 7, further comprising:
picking a kinematic variation in the synthetic common image gather; and
generating the velocity model by minimizing the kinematic variation.

9. The method of claim 8, wherein the kinematic variation is associated with a residual normal moveout curve in the synthetic common image gather.

10. The method of claim 8, further comprising:
migrating the synthetic gather F with the velocity model to obtain an improved synthetic common image gather.

11. The method of claim 1, wherein the step of generating uses reflectivity tomographic inversion to generate the velocity model.

12. The method of claim 1, wherein the synthetic gather F is calculated free of an initial velocity model.

13. A computing system for mapping near-surface velocities to layers of a subsurface, the computing system comprising:
an interface configured to receive seismic data D associated with the subsurface, wherein the seismic data D includes at least one of P-wave energy, S-wave energy, or a mixture of P- and S-wave energy; and
a processor connected to the interface and configured to,
apply a predictive deconvolution method to the seismic data D to calculate a synthetic gather F, of the subsurface; and
generate a velocity model of the subsurface based on the synthetic gather F, wherein the velocity model maps near-surface velocities to the layers of the subsurface,
wherein a prediction deconvolution operator of the predictive deconvolution method, which corresponds to the synthetic gather F with changed sign, is a Green's function of the subsurface without any free surface.

14. The computing system of claim 13, wherein the synthetic gather F is calculated based on the seismic data D, and a convolution term between the seismic data D and contaminated primaries P, where the contaminated primaries P includes pure primaries and internal multiples.

15. The computing system of claim 14, wherein the convolution term between the seismic data D and the contaminated primaries P is multiplied by an inverse of a source wavelet s, which describes a source that generates the seismic data D.

16. The computing system of claim 14, wherein the convolution term convolves the seismic data D with the contaminated primaries P, in this order, to obtain a receiver-side synthetic gather F, and the convolution term convolves the contaminated primaries P with the seismic data D, in this order, to obtain a source-side synthetic gather F.

17. The computing system of claim 13, wherein the synthetic gather F is a function of (1) time, (2) a position of a source that generates the seismic data D, and (3) a position of a receiver that records the seismic data D.

18. The computing system of claim 13, wherein the processor is further configured to:
migrate the synthetic gather F to obtain a synthetic common image gather;
pick a kinematic variation in the synthetic common image gather; and
generate the velocity model by minimizing the kinematic variation, wherein the kinematic variation is associated with a residual normal moveout curve in the synthetic common image gather.

19. The computing system of claim 13, wherein the step of generating uses reflectivity tomographic inversion to generate the velocity model, and the synthetic gather F is calculated free of an initial velocity model.

20. A non-transitory computer readable medium including computer executable instructions, wherein the instructions, when executed by a processor, implement a method for mapping near-surface velocities to layers of a subsurface, the medium comprising instructions for:
receiving seismic data D associated with the subsurface, wherein the seismic data D includes at least one of P-wave energy, S-wave energy, or a mixture of P- and S-wave energy;
applying a predictive deconvolution method to the seismic data D to calculate a synthetic gather F, of the subsurface; and
generating a velocity model of the subsurface based on the synthetic gather F, wherein the velocity model maps near-surface velocities to the layers of the subsurface,
wherein a prediction deconvolution operator of the predictive deconvolution method, which corresponds to the synthetic gather F with changed sign, is a Green's function of the subsurface without any free surface.
